(19) United States
(12) Patent Application Publication
(10) Pub. No.: US 2018/0277965 A1
(43) Pub. Date: Sep. 27, 2018

(54) Multi wire cable connector assembly

(71) Applicant: Avtarjeet Singh Dhanjal, Ironbridge (GB)

(72) Inventor: Avtarjeet Singh Dhanjal, Ironbridge (GB)

(21) Appl. No.: 15/626,937

(22) Filed: Jun. 19, 2017

(30) Foreign Application Priority Data
Mar. 26, 2017 (GB) 1704781.2

(51) Int. Cl. H01R 4/48; H01R 9/22

(52) U.S. Cl. CPC H01R 4/4836; H01R 9/223

(57) ABSTRACT

A multiwire cable connector having a connector body (028) suitable for hosting a plurality of electrical wires is provided. The multiwire cable connector optionally having a release mechanism to allow repeat usage in the connection of wires with different electrical polarity.

### CROSS-REFERENCE TO RELATED APPLICATIONS

This application relates to and claims the benefit of prior GB application 1704781.2 filed on Mar. 26, 2017, incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to wire and cable connectors, in particular it relates to releasable and non-releasable multi-wire connectors suitable for linking of multi core cables.

### BACKGROUND OF THE INVENTION

Electricians, and other individuals, facing the problem of having to connect two wires of the same polarity together resort to using releasable and non-releasable single pole connectors. Such connectors, for example the WAGO series of connectors, are inherently limited by their features and design to being able to connect wires only of one polarity.

Furthermore electricians, and other individuals, facing the problem of connecting 2-, 3- or more core cables together must resort to the use of multiple single wire connectors. Such activity is time consuming, and requires significant space surrounding the cables to host two, three or more individual wire connectors

### SUMMARY OF THE INVENTION

Unfortunately, existing wire connectors therefore lack convenience and utility in the connection of 2-, 3- and more core cables.

It is an aim of the present invention to address the problem of connecting cable having multi wires of different polarities

It is an object of the present invention to provide a cable connector suitable to hold, connect and/or terminate a plurality of electrical cables, or sets of wires, wherein each cable, or set of wires, comprises a plurality of wires of different electrical polarities/potentials i.e. Live, Neutral Earth, or different voltage and other such, being housed safely within a single connector whilst maintaining their electrical polarities.

It is an object of the present invention to safely connect/bridge selected terminals keeping them fully isolated and electrically insulated within a single connector assembly.

It is an object of the present invention to provide a wire/cable connector suitable for holding a wires releasably for multi time usage, or alternatively non-releasably for single use only.

These, and other, objectives are achieved by a connector assembly having a plurality of electrical terminals, wherein each terminal comprises a contact plate, a compression spring suitable for retaining the bare end of an electrical wire with the contact plate, all the aforementioned elements all housed within a cell made from a non-conducting material.

In one embodiment of the multi wire cable connector assembly, wires of each cable or ‘set of wires’ irrespective of different electrical polarities being releasable by single actuation of a button, lever or cam/clamp.

In another embodiment of the present invention, the multi wire cable connector assembly may further be engaged mechanically and electrically to a functional device, for example a socket, a switch or other such device known in the art.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention.

### BRIEF DESCRIPTION OF THE DRAWINGS

The accompanying drawing(s), which are incorporated in and constitute a part of this specification, illustrate several aspects described below.

FIG. 1 illustrates, a back-to-back cable connector, equipped to receive and connect two cables each having three wires, marked for their polarity, further having a single release button (023b) for each cable/set of wires (03);

FIG. 2 illustrates, an expanded view of the connector (02) having a body (021) and connector terminal (02T).

FIG. 3 illustrates a further cross-sectional view of the back-to-back cable connector with half height slider (022)

FIG. 4 illustrates a further cross-sectional view of the back-to-back cable connector with slider (022) screened for clarity, having left slider vertically extending top to bottom with the Connector body, and a half height slider expressed on the right.

FIG. 5 illustrates a back to back 4-cable (03) connector (021) each with 3 wires 03(1), providing a mechanism (023c), for example a clamp, to hold and release each set of wires/cables individually.

FIG. 6 illustrates another embodiment of the present invention (02n), a back-to-back cable connector capable of receiving and connecting 4 cables (sets of wires) (03), without any facility to release the set of wires—cable (03)

FIG. 7 illustrates a further cross-sectional view of the back-to-back cable connector (02n) without a wire release mechanism.

FIG. 8 illustrates an embodiment of the cable connector (02) of the present invention.

FIG. 9 illustrates another embodiment of the present invention, a cable connector with a facility to receive, hold and connect 3 sets of wires (cables) (03) each comprising wires (031) of different polarities, wherein the wires (031) of each electrical polarity being bridged/connected internally using a contact plate (024a).

FIG. 10-12 illustrate embodiments of three different polarity contact plates (024) being interconnected internally and isolated from wires having different polarities using the multiwire cable connector (02) of the present invention.

FIG. 13 illustrates the out-put face (027) of the connector (02) having three female apertures (027L), (027E) and (027N) to connect/mate with tree male pins/prongs of an electrical functional device (01).

FIG. 14 illustrates an embodiment of the cable connector of the present invention embedded in a socket (functional device) 01.

FIG. 15 illustrates an embodiment of the cable connector of the present invention embedded in a switch (functional device) 01.

Further description of the individual elements, consistent with the present invention, for each figure is provided below:

### REFERENCE NUMERALS

01 A functional device
02 A multiwire cable connector assembly with wire release function
02n A multiwire cable connector assembly without wire release function
03 Electrical cable
031 Electrical wire,
021. Connector Body
0211 Connector Cell,
02T Connector Terminal,
022. Sliding Module
023. Actuation Module
023a Pressure Point,
023b Actuation Button,
023c Actuation clamp which has number of pressure points (023a) to press down the spring element.
024. Contact Plate
024a Contact link/Bridge
025. Compression Spring Element
026. Wire Receiving Aperture,
027. Out-put Interface, 028L, 028E & 028N etc. female output terminals,
028. Connector Body

The letter extensions L, E, N denote electrical polarities such as Live/Hot, Earth/Ground and Neutral respectively.

### DETAILED DESCRIPTION OF THE PREFERRED EMBODIMENTS

It is to be understood that this invention is not limited to particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience and disclosure found in any section may be combined with that in another section. Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context clearly dictates otherwise

### I. Definitions

Unless defined otherwise, all technical and scientific terms used herein have the same meaning as commonly understood by one of ordinary skill in the art to which this invention belongs. As used herein the following terms have the following meanings.

“Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a device consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

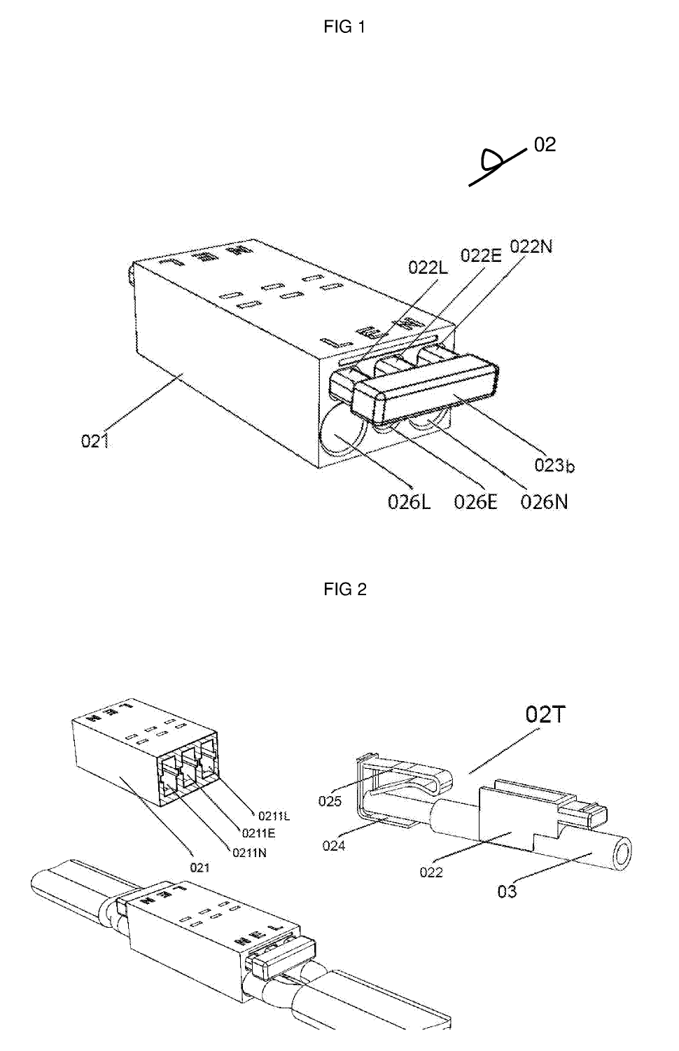

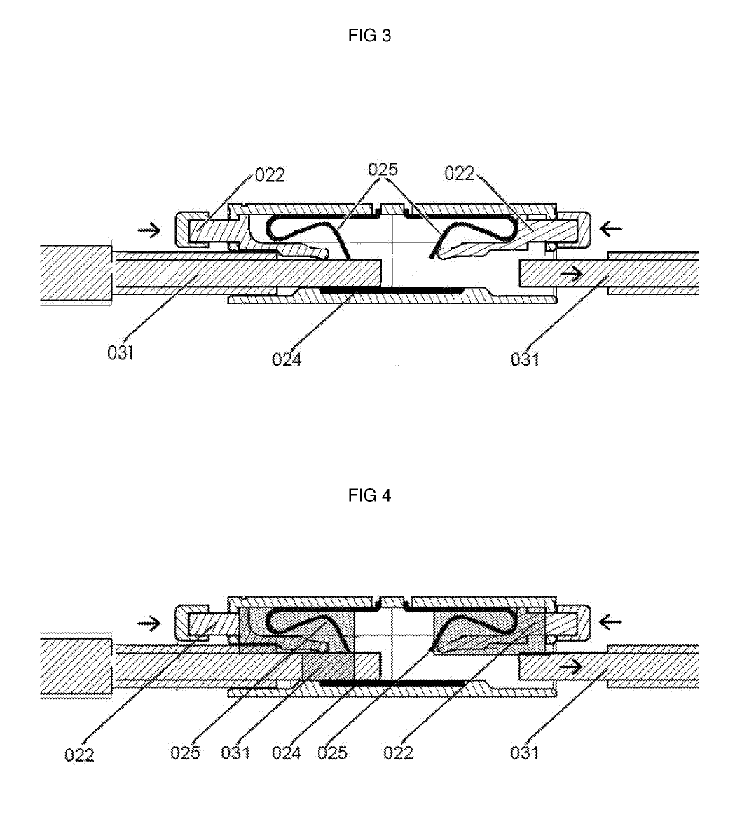

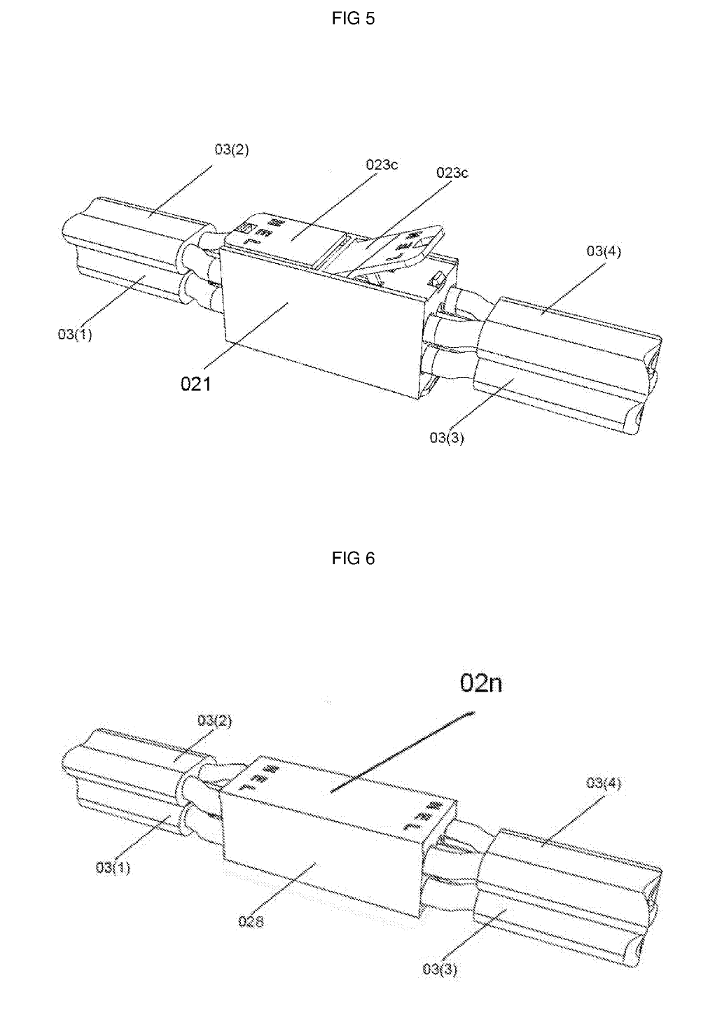

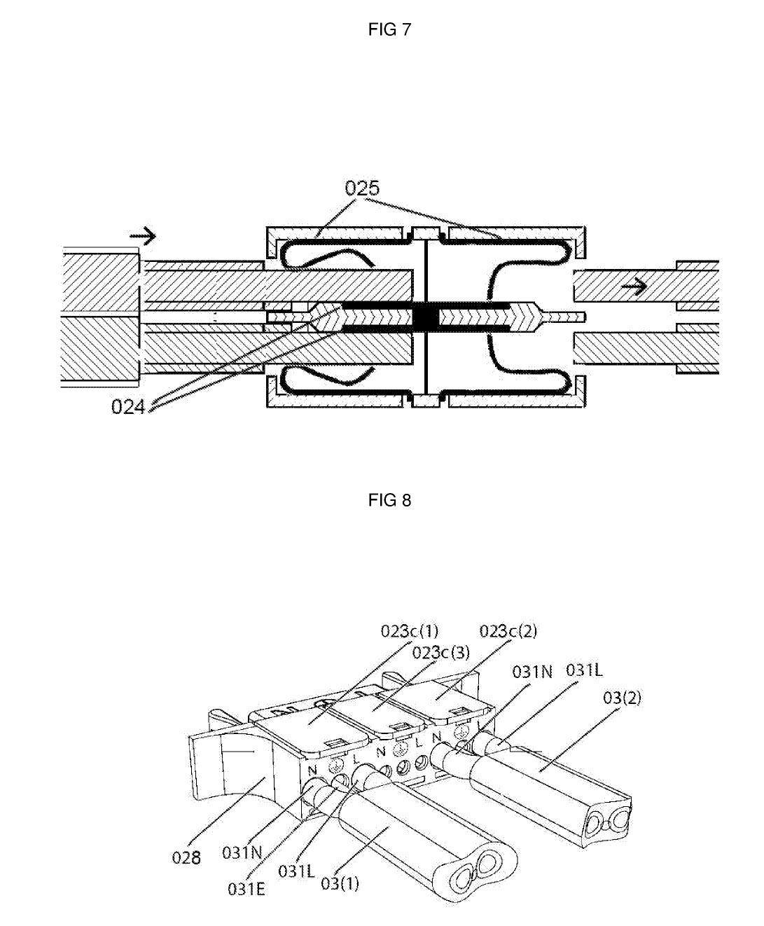

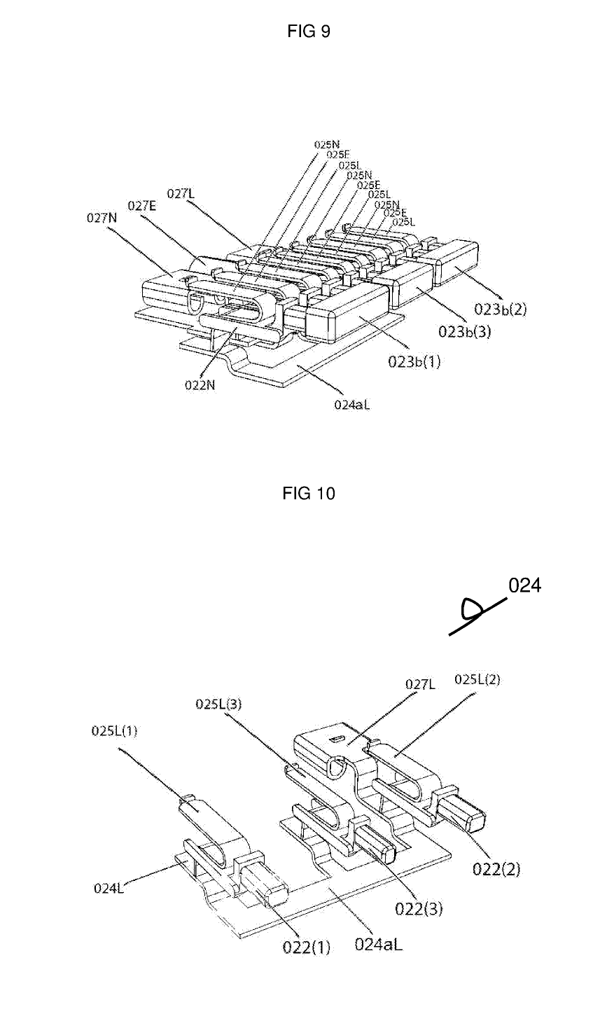

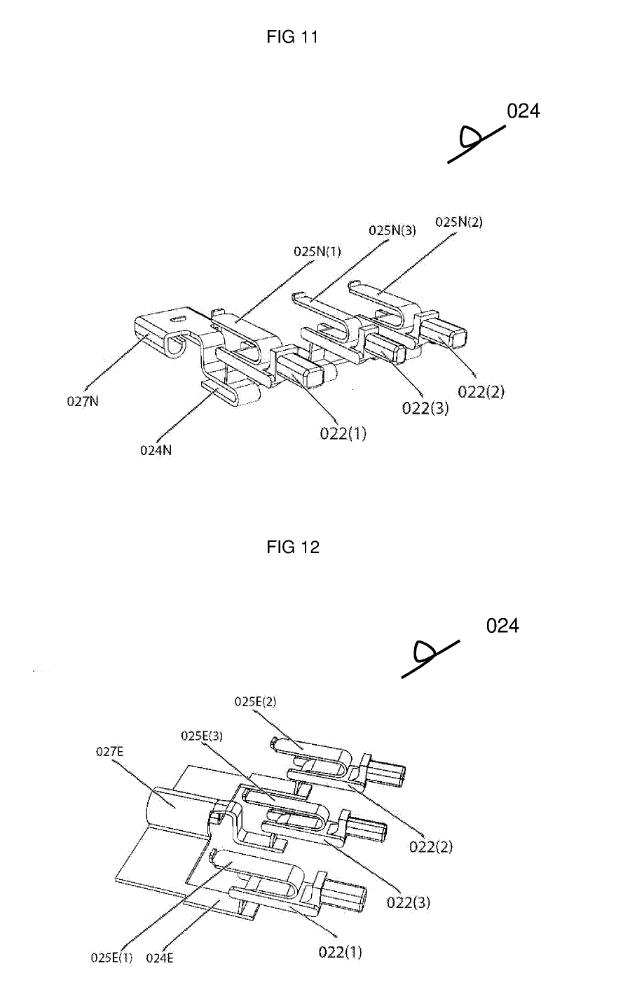

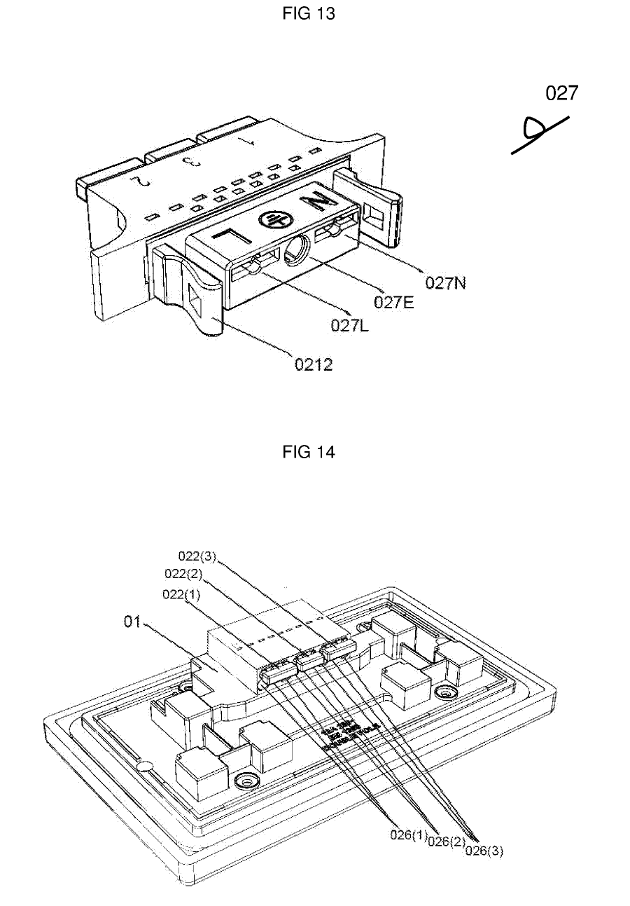

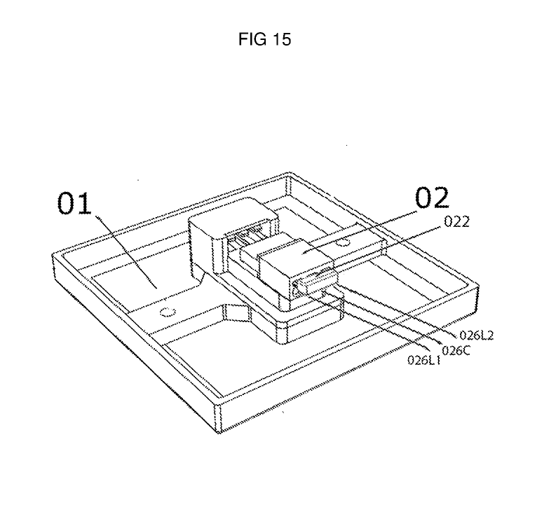

The multiwire cable connector of the present invention is further described with reference to FIGS. 1-15.

The present invention—a multiwire cable connector assembly (02) comprises a plurality of individual cells (0211), each cell (0211) comprising a contact plate (024), a compression spring (025) suitable to hold a bare end of hard conductor/wire (031) tight against the contact plate (024), the connector body (028) having a plurality of individual cells (0211) each having an input aperture (026) on its input face to receive a wire (031);

The connector assembly (02) comprises a plurality of terminals (02T), arranged in groups, terminals within each group are arranged in a logical sequence as the wires (031) in flat cables (03) thus each wire (031) from any one cable/set may be inserted and connected directly without physically crossing over other wires, thus maintaining their electrical polarity i.e. Live/Hot, neutral and Earth Ground thus avoiding any confusion to the installer/s.

Additionally, each electrical polarity is linked/bridged internally and kept isolated and insulated safely within a single multiwire cable connector assembly (02);

Embodiments of the multiwire cable connector assembly (02) described herein functions enable the user to:

a. perform safe termination of a cable or a set of wires of different electrical polarities;
b. directly connect of two or more cables or sets of wires (03), using a single connector assembly;
c. or the multiwire cable connector assembly (02) is suitable for use as an intermediate device for connecting a single or multiple cables or sets of wires (03) on one side and the other side is connectible electrically and mechanically to an electrical functional device i.e. a switch, a wall socket/outlet or other such (01).

Additionally, in one embodiment of the multiwire cable connector assembly (02) the wire terminals receive and hold wires/cables (03) which are releasable by actuation of a slider (023b), lever, cam/clamp (023c/d) or other such mechanism. In other embodiments no such facility for releasing the wires is provided, such multiwire cable connector assemblies (02) being for one-time use only.

In the releasable multiwire cable connector assembly (02), any ‘one set of wires’ (sheathed cable) (03) may be held or released by single actuation of a slider (023b), lever or cam/clamp (023c) even though set of wires or the cable may comprise wires of different electrical polarities;

The multiwire cable connector (02) further provides a facility to release each cable (comprising multiple of wires of different polarities) or a set of wires (03) with a single operation of either pushing a button (023b) or actuation of a lever, cam/clamp (023c).

Thus the multiwire cable connector (02) having a connector body (021) suitable for receiving, holding and terminating a plurality of sheathed multi wire cables, wherein said wires having different polarities, having at least one aperture (026) for receiving an electrical wire (031), and at least one electrical terminal, housed within in a cell (0211) constructed from a non-conductive material, said cell (0211) comprising, a contact plate (024), a compression spring (025) for engagement of an electrical wire (031) with the contact plate (024), may be employed by the electrician as follows:

inserting bare ends of electrical wires (031) via apertures (026) into cells (021), as required until all wires (031) of the 2, 3 or more-core cable are engaged with the contact plate (024) of cell (021) such that the hair-pin compression spring (025) retains the bare end of each electrical wire with the contact plate (024).

In embodiments of the multi wire cable connector assembly (02), optionally releasing electrical wires (031) via engagement of the releasing mechanism, by single actuation of the slider (023b), lever or cam/clamp (023c).

Optionally the above method further includes embodiments wherein the multiwire cable connector (02) is part of a functional device.

1. A multiwire cable connector (02) with a body (028) suitable for receiving, holding and terminating a plurality of multi wire cables, said wires having different electrical polarities, comprising:
at least one aperture (026) for receiving an electrical wire (031), and
at least one electrical terminal, housed within in a cell (021) constructed from a non-conductive material, said cell (021) having,
a contact plate (024), a compression spring (025) for engagement of an electrical wire (031) with the contact plate (024).

2. The multiwire cable connector of claim 1, wherein the plurality of contact plates of same polarity are linked or bridges across cells.

3. The multiwire cable connector of claim 1, wherein each cell (021) further comprises a wire release mechanism.

4. The multiwire cable connector of claim 3, wherein the release mechanism is a slider (023b), lever, cam/clamp (023c/d) or other releasing mechanism.

5. The multiwire cable connector of any one of the above claim 1, electrically or mechanically engaged with a switch, a socket or other functional device.

6. A method for using a multiwire cable connector of claim 1, comprising:
providing a multiwire cable connector (02) with a connector body (028) suitable for receiving, holding and terminating a plurality of multi wire cables, wherein said wires having different polarities, having at least one aperture (026) for receiving an electrical wire (031), and at least one electrical terminal, housed within in a cell (021) constructed from a non-conductive material, said cell (021) comprising, a contact plate (024), a compression spring (025) for engagement of an electrical wire (031) with the contact plate (024),
inserting electrical wires (031) via apertures (026) into cells (021),
engaging the electrical wire (031) with contact plate (024),
optionally releasing electrical wires (031) via engagement of a releasing mechanism.
